(19) United States
(12) Patent Application Publication
(10) Pub. No.: US 2026/0167224 A1
(43) Pub. Date: Jun. 18, 2026

(54) SYSTEM AND METHOD FOR AUTONOMOUS VEHICLE PATH SELECTION

(71) Applicant: GM Global Technology Operations LLC, Detroit, MI (US)

(72) Inventors: Namal P. Kumara, Ypsilanti, MI (US); Paul A. Adam, Milford, MI (US); Jeffrey Scott Parks, Ann Arbor, MI (US)

(21) Appl. No.: 18/983,933

(22) Filed: Dec. 17, 2024

(51) Int. Cl. B60W 60/00; B60W 50/14

(52) U.S. Cl. CPC B60W 60/0011; B60W 50/14; B60W 2050/146; B60W 2520/10; B60W 2552/00; B60W 2554/406; B60W 2556/40; B60W 2556/50

(57) ABSTRACT

A method for operating an autonomous vehicle may include generating a plurality of possible paths. The method further may include identifying one or more decision points along each of the plurality of possible paths. The method further may include determining a complexity score of each of the one or more decision points along each of the plurality of possible paths. The method further may include determining an optimal path based at least in part on the complexity score of each of the one or more decision points along each of the plurality of possible paths. The method further may include adjusting an operation of the autonomous vehicle based at least in part on the optimal path.

### INTRODUCTION

The present disclosure relates to systems and methods for advanced driver assistance systems (ADAS) and automated driving systems (ADS) for vehicles.

To enable ADAS and ADS functionality, various sensors and computational systems work together to monitor and interpret the vehicle’s surroundings. Sensors such as cameras, radar, LiDAR, and ultrasonic devices collect data about nearby objects, road conditions, and traffic patterns. This information is processed by onboard computing systems, which use algorithms to identify objects, predict their movements, and determine appropriate responses. For example, cameras may detect lane markings and traffic signs, radar may track the speed and distance of nearby vehicles, and lidar can create detailed 3D maps of the environment. Based on this data, the system can perform tasks such as lane keeping, adaptive cruise control, emergency braking, and automated steering. Automated driving systems (ADS) further extend these capabilities by using deterministic methods or machine learning models to analyze complex scenarios and make decisions for fully autonomous driving.

While systems and methods for ADAS and ADS achieve their intended purpose, there is a need for new and improved systems and methods for operating autonomous vehicles.

### SUMMARY

According to several aspects, a method for operating an autonomous vehicle is provided. The method may include generating a plurality of possible paths. The method further may include identifying one or more decision points along each of the plurality of possible paths. The method further may include determining a complexity score of each of the one or more decision points along each of the plurality of possible paths. The method further may include determining an optimal path based at least in part on the complexity score of each of the one or more decision points along each of the plurality of possible paths. The method further may include adjusting an operation of the autonomous vehicle based at least in part on the optimal path.

In another aspect of the present disclosure, determining the complexity score of each of the one or more decision points further may include determining the complexity score of each of the one or more decision points based at least in part on a road configuration within a first predetermined radius of each of the one or more decision points. The complexity score is positively correlated with a complexity of the road configuration.

In another aspect of the present disclosure, determining the complexity score of each of the one or more decision points further may include determining the complexity score of each of the one or more decision points based at least in part on the plurality of possible paths. The complexity score of a first decision point of the one or more decision points along a first possible path of the plurality of possible paths is negatively correlated with a shortest distance between the first decision point and any location along the first possible path.

In another aspect of the present disclosure, determining the complexity score of each of the one or more decision points further may include determining the complexity score of each of the one or more decision points based at least in part on a traffic condition within a second predetermined radius of each of the one or more decision points. The complexity score is positively correlated with a complexity of the traffic condition.

In another aspect of the present disclosure, determining the complexity score of each of the one or more decision points further may include determining the complexity score of each of the one or more decision points based at least in part on a speed of the autonomous vehicle. The complexity score is positively correlated with the speed of the autonomous vehicle.

In another aspect of the present disclosure, determining the optimal path based at least in part on the complexity score of each of the one or more decision points along each of the plurality of possible paths further may include calculating a total complexity score of each of the plurality of possible paths by summing the complexity score of each of the one or more decision points along each of the plurality of possible paths. Determining the optimal path based at least in part on the complexity score of each of the one or more decision points along each of the plurality of possible paths further may include determining the optimal path to be one of the plurality of possible paths having a lowest total complexity score.

In another aspect of the present disclosure, determining the optimal path based at least in part on the complexity score of each of the one or more decision points along each of the plurality of possible paths further may include comparing the complexity score of each of the one or more decision points along each of the plurality of possible paths to a predetermined complexity threshold. Determining the optimal path based at least in part on the complexity score of each of the one or more decision points along each of the plurality of possible paths further may include identifying zero or more complex decision points along each of the plurality of possible paths. The complexity score of each of the zero or more complex decision points is greater than the predetermined complexity threshold. Determining the optimal path based at least in part on the complexity score of each of the one or more decision points along each of the plurality of possible paths further may include determining the optimal path to be one of the plurality of possible paths having a lowest total complexity score and having a least amount of complex decision points.

In another aspect of the present disclosure, adjusting the operation of the autonomous vehicle further may include configuring an automated driving system of the autonomous vehicle to follow the optimal path. Adjusting the operation of the autonomous vehicle further may include providing an alert to an occupant of the autonomous vehicle in response to determining that at least one of the one or more decision points along the optimal path is one of the zero or more complex decision points.

In another aspect of the present disclosure, generating the plurality of possible paths further may include determining a route to a destination based at least in part on a location of the autonomous vehicle. Generating the plurality of possible paths further may include generating the plurality of possible paths along the route based at least in part on a detailed map along the route. Each of the plurality of possible paths includes a possible trajectory for the autonomous vehicle.

In another aspect of the present disclosure, identifying the one or more decision points further may include identifying the one or more decision points along each of the plurality of possible paths based at least in part on a road configuration along each of the plurality of possible paths.

According to several aspects, a system for operating an autonomous vehicle is provided. The system may include one or more vehicle sensors, an automated driving system, and a vehicle controller in electrical communication with the one or more vehicle sensors and the automated driving system. The vehicle controller is programmed to determine a route to a destination based at least in part on a location of the autonomous vehicle determined using the one or more vehicle sensors. The vehicle controller is further programmed to generate a plurality of possible paths along the route based at least in part on a detailed map along the route. Each of the plurality of possible paths includes a possible trajectory for the autonomous vehicle. The vehicle controller is further programmed to identify one or more decision points along each of the plurality of possible paths. The vehicle controller is further programmed to determine a complexity score of each of the one or more decision points along each of the plurality of possible paths. The vehicle controller is further programmed to determine an optimal path based at least in part on the complexity score of each of the one or more decision points along each of the plurality of possible paths. The vehicle controller is further programmed to adjust an operation of the automated driving system based at least in part on the optimal path.

In another aspect of the present disclosure, to determine the complexity score of each of the one or more decision points, the vehicle controller is further programmed to determine the complexity score of each of the one or more decision points based at least in part on a road configuration within a first predetermined radius of each of the one or more decision points. The complexity score is positively correlated with a complexity of the road configuration. To determine the complexity score of each of the one or more decision points, the vehicle controller is further programmed to determine the complexity score of each of the one or more decision points based at least in part on the plurality of possible paths. The complexity score of a first decision point of the one or more decision points along a first possible path of the plurality of possible paths is negatively correlated with a shortest distance between the first decision point and any location along the first possible path. To determine the complexity score of each of the one or more decision points, the vehicle controller is further programmed to determine the complexity score of each of the one or more decision points based at least in part on a traffic condition within the first predetermined radius of each of the one or more decision points. The complexity score is positively correlated with a complexity of the traffic condition.

In another aspect of the present disclosure, determine the complexity score of each of the one or more decision points, the vehicle controller is further programmed to determine the complexity score of each of the one or more decision points based at least in part on a location of the autonomous vehicle. The complexity score of a second decision point of the one or more decision points along a second possible path of the plurality of possible paths is negatively correlated with a distance between the second decision point and the location of the autonomous vehicle.

In another aspect of the present disclosure, determine the optimal path based at least in part on the complexity score of each of the one or more decision points along each of the plurality of possible paths, the vehicle controller is further programmed to calculate a total complexity score of each of the plurality of possible paths by summing the complexity score of each of the one or more decision points along each of the plurality of possible paths. Determine the optimal path based at least in part on the complexity score of each of the one or more decision points along each of the plurality of possible paths, the vehicle controller is further programmed to determine the optimal path to be one of the plurality of possible paths having a lowest total complexity score.

In another aspect of the present disclosure, to determine the optimal path based at least in part on the complexity score of each of the one or more decision points along each of the plurality of possible paths, the vehicle controller is further programmed to compare the complexity score of each of the one or more decision points along each of the plurality of possible paths to a predetermined complexity threshold. To determine the optimal path based at least in part on the complexity score of each of the one or more decision points along each of the plurality of possible paths, the vehicle controller is further programmed to identify zero or more complex decision points along each of the plurality of possible paths. The complexity score of each of the zero or more complex decision points is greater than the predetermined complexity threshold. To determine the optimal path based at least in part on the complexity score of each of the one or more decision points along each of the plurality of possible paths, the vehicle controller is further programmed to determine the optimal path to be one of the plurality of possible paths having a lowest total complexity score and having a least amount of complex decision points.

In another aspect of the present disclosure, the system further includes a display in electrical communication with the vehicle controller. To adjust the operation of the automated driving system, the vehicle controller is further programmed to configure the automated driving system of the autonomous vehicle to follow the optimal path. To adjust the operation of the automated driving system, the vehicle controller is further programmed to provide an alert to an occupant of the autonomous vehicle using the display in response to determining that at least one of the one or more decision points along the optimal path is one of the zero or more complex decision points.

In another aspect of the present disclosure, to identify the one or more decision points, the vehicle controller is further programmed to identify the one or more decision points along each of the plurality of possible paths based at least in part on a road configuration along each of the plurality of possible paths. The road configuration is determined based at least in part on the detailed map.

According to several aspects, a method for operating an autonomous vehicle is provided. The method may include determining a route to a destination based at least in part on a location of the autonomous vehicle. The method further may include generating a plurality of possible paths along the route based at least in part on a detailed map along the route. Each of the plurality of possible paths includes a possible trajectory for the autonomous vehicle. The method further may include identifying one or more decision points along each of the plurality of possible paths based at least in part on the detailed map along each of the plurality of possible paths. Each of the one or more decision points indicates a change in a road configuration along the route. The method further may include determining a complexity score of each of the one or more decision points along each of the plurality of possible paths. The method further may include determining an optimal path based at least in part on the complexity score of each of the one or more decision points along each of the plurality of possible paths. The method further may include configuring an automated driving system of the autonomous vehicle to follow the optimal path.

In another aspect of the present disclosure, determining the complexity score of each of the one or more decision points further may include determining the complexity score of each of the one or more decision points based at least in part on a road configuration within a first predetermined radius of each of the one or more decision points. The complexity score is positively correlated with a complexity of the road configuration. Determining the complexity score of each of the one or more decision points further may include determining the complexity score of each of the one or more decision points based at least in part on the plurality of possible paths. The complexity score of a first decision point of the one or more decision points along a first possible path of the plurality of possible paths is negatively correlated with a shortest distance between the first decision point and any location along the first possible path. Determining the complexity score of each of the one or more decision points further may include determining the complexity score of each of the one or more decision points based at least in part on a traffic condition within the first predetermined radius of each of the one or more decision points. The complexity score is positively correlated with a complexity of the traffic condition. Determining the complexity score of each of the one or more decision points further may include determining the complexity score of each of the one or more decision points based at least in part on a speed of the autonomous vehicle. The complexity score is positively correlated with the speed of the autonomous vehicle. Determining the complexity score of each of the one or more decision points further may include determining the complexity score of each of the one or more decision points based at least in part on a location of the autonomous vehicle. The complexity score of a second decision point of the one or more decision points along a second possible path of the plurality of possible paths is negatively correlated with a distance between the second decision point and the location of the autonomous vehicle.

In another aspect of the present disclosure, determining the optimal path based at least in part on the complexity score of each of the one or more decision points along each of the plurality of possible paths further may include comparing the complexity score of each of the one or more decision points along each of the plurality of possible paths to a predetermined complexity threshold. Determining the optimal path based at least in part on the complexity score of each of the one or more decision points along each of the plurality of possible paths further may include identifying zero or more complex decision points along each of the plurality of possible paths. The complexity score of each of the zero or more complex decision points is greater than the predetermined complexity threshold. Determining the optimal path based at least in part on the complexity score of each of the one or more decision points along each of the plurality of possible paths further may include calculating a total complexity score of each of the plurality of possible paths by summing the complexity score of each of the one or more decision points along each of the plurality of possible paths. Determining the optimal path based at least in part on the complexity score of each of the one or more decision points along each of the plurality of possible paths further may include determining the optimal path to be one of the plurality of possible paths having a lowest total complexity score and having a least amount of complex decision points.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for operating an autonomous vehicle, according to an exemplary embodiment;

FIG. 2 is a flowchart of a method for operating an autonomous vehicle, according to an exemplary embodiment;

FIG. 3A is a schematic diagram of a first exemplary roadway, according to an exemplary embodiment;

FIG. 3B is a schematic diagram of a second exemplary roadway, according to an exemplary embodiment; and

FIG. 3C is a schematic diagram of a third exemplary roadway, according to an exemplary embodiment.

### DETAILED DESCRIPTION

The following description is merely exemplary in nature and is not intended to limit the present disclosure, application, or uses.

In aspects of the present disclosure, there may be multiple potential paths which an autonomous vehicle may take to navigate an environment. Accordingly, the present disclosure provides a new and improved system and method for operating an autonomous vehicle which includes selection of an optimal path to navigate the environment.

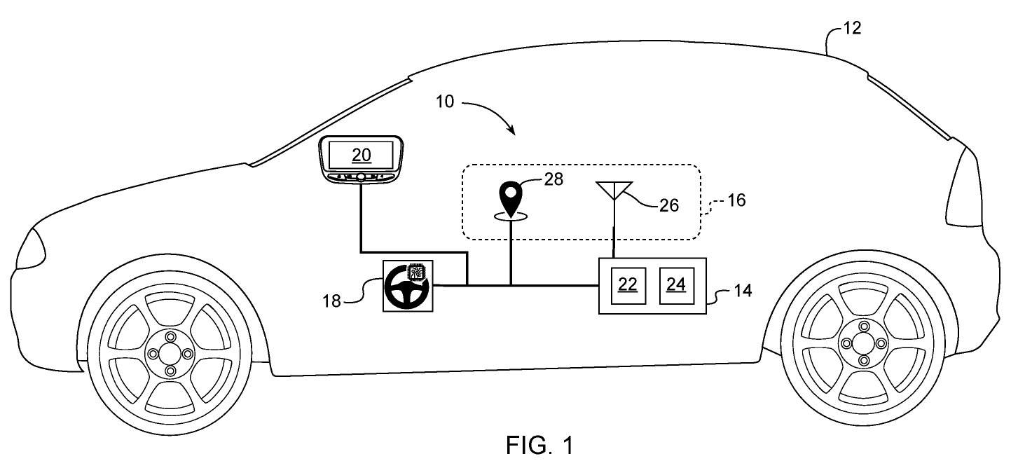

Referring to FIG. 1, a system for operating an autonomous vehicle is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. In an exemplary embodiment, the vehicle 12 is an autonomous vehicle including systems allowing for autonomous operation, as will be discussed in greater detail below. The system 10 generally includes a vehicle controller 14, one or more vehicle sensors 16, an automated driving system 18, and a display 20.

The vehicle controller 14 is used to implement a method 100 for operating an autonomous vehicle, as will be described below. The vehicle controller 14 includes at least one processor 22 and a non-transitory computer readable storage device or media 24. The processor 22 may be a custom made or commercially available processor, a central processing unit (CPU), a graphics processing unit (GPU), an auxiliary processor among several processors associated with the vehicle controller 14, a semiconductor-based microprocessor (in the form of a microchip or chip set), a macroprocessor, a combination thereof, or generally a device for executing instructions.

The computer readable storage device or media 24 may include volatile and nonvolatile storage in read-only memory (ROM), random-access memory (RAM), and keep-alive memory (KAM), for example. KAM is a persistent or non-volatile memory that may be used to store various operating variables while the processor 22 is powered down. The computer-readable storage device or media 24 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the vehicle controller 14 to control various systems of the vehicle 12.

The vehicle controller 14 may also include multiple controllers which are in electrical communication with each other. The vehicle controller 14 may be inter-connected with additional systems and/or controllers of the vehicle 12, allowing the vehicle controller 14 to access data such as, for example, speed, acceleration, braking, and steering angle of the vehicle 12.

The vehicle controller 14 is in electrical communication with the one or more vehicle sensors 16, the automated driving system 18, and the display 20. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the vehicle controller 14 are within the scope of the present disclosure. It should further be understood that, in the scope of the present disclosure, electrical communication also includes power and/or energy transfer between electrical devices (e.g., using conducting wires and/or wireless power transmission techniques).

The one or more vehicle sensors 16 are used to acquire information relevant to the vehicle 12. In an exemplary embodiment, the one or more vehicle sensors 16 includes a vehicle communication system 26 and a global navigation satellite system (GNSS) 28.

In another exemplary embodiment, the one or more vehicle sensors 16 further includes sensors to determine performance and telemetry data about the vehicle 12. In a non-limiting example, the one or more vehicle sensors 16 further includes at least one of a motor speed sensor, a motor torque sensor, an electric drive motor voltage and/or current sensor, an accelerator pedal position sensor, a brake position sensor, a coolant temperature sensor, a cooling fan speed sensor, and a transmission oil temperature sensor. In a non-limiting example, the one or more vehicle sensors 16 further includes an accelerometer, a compass, an inertial measurement unit (IMU), and/or the like.

In another exemplary embodiment, the one or more vehicle sensors 16 further includes sensors to determine information about an environment within the vehicle 12. In a non-limiting example, the one or more vehicle sensors 16 further includes at least one of a seat occupancy sensor, a cabin air temperature sensor, a cabin motion detection sensor, a cabin camera, a cabin microphone, and/or the like.

In another exemplary embodiment, the one or more vehicle sensors 16 further includes sensors to determine information about an environment surrounding the vehicle 12. In a non-limiting example, the one or more vehicle sensors 16 further includes at least one of an ambient air temperature sensor, a barometric pressure sensor, and/or a photo and/or video camera which is positioned to view the environment in front of the vehicle 12.

In another exemplary embodiment, at least one of the one or more vehicle sensors 16 is a perception sensor capable of perceiving objects and/or measuring distances in the environment surrounding the vehicle 12. In a non-limiting example, the one or more vehicle sensors 16 includes a camera and/or a stereoscopic camera having distance measurement capabilities. In one example, at least one of the one or more vehicle sensors 16 is affixed inside of the vehicle 12, for example, in a headliner of the vehicle 12, having a view through a windscreen of the vehicle 12. In another example, at least one of the one or more vehicle sensors 16 is affixed outside of the vehicle 12, for example, on a roof of the vehicle 12, having a view of the environment surrounding the vehicle 12. It should be understood that various additional types of perception sensors, such as, for example, LiDAR sensors, ultrasonic ranging sensors, radar sensors, and/or time-of-flight sensors are within the scope of the present disclosure. The one or more vehicle sensors 16 are in electrical communication with the vehicle controller 14 as discussed above.

The vehicle communication system 26 is used by the vehicle controller 14 to communicate with other systems external to the vehicle 12. For example, the vehicle communication system 26 includes capabilities for communication with vehicles (“V2V” communication), infrastructure (“V2I” communication), remote systems at a remote call center (e.g., ON-STAR by GENERAL MOTORS) and/or personal devices. In general, the term vehicle-to-everything communication (“V2X” communication) refers to communication between the vehicle 12 and any remote system (e.g., vehicles, infrastructure, and/or remote systems).

In certain embodiments, the vehicle communication system 26 is a wireless communication system configured to communicate via a wireless local area network (WLAN) using IEEE 802.11 standards or by using cellular data communication (e.g., using GSMA standards, such as, for example, SGP.02, SGP.22, SGP.32, and the like). Accordingly, the vehicle communication system 26 may further include an embedded universal integrated circuit card (eUICC) configured to store at least one cellular connectivity configuration profile, for example, an embedded subscriber identity module (eSIM) profile.

The vehicle communication system 26 is further configured to communicate via a personal area network (e.g., BLUETOOTH), near-field communication (NFC), and/or any additional type of radiofrequency communication. However, additional or alternate communication methods, such as a dedicated short-range communications (DSRC) channel and/or mobile telecommunications protocols based on the 3rd Generation Partnership Project (3GPP) standards, are also considered within the scope of the present disclosure. DSRC channels refer to one-way or two-way short-range to medium-range wireless communication channels specifically designed for automotive use and a corresponding set of protocols and standards. The 3GPP refers to a partnership between several standards organizations which develop protocols and standards for mobile telecommunications. 3GPP standards are structured as “releases”. Thus, communication methods based on 3GPP release 14, 15, 16 and/or future 3GPP releases are considered within the scope of the present disclosure.

Accordingly, the vehicle communication system 26 may include one or more antennas and/or communication transceivers for receiving and/or transmitting signals, such as cooperative sensing messages (CSMs). The vehicle communication system 26 is configured to wirelessly communicate information between the vehicle 12 and another vehicle. Further, the vehicle communication system 26 is configured to wirelessly communicate information between the vehicle 12 and infrastructure or other vehicles. It should be understood that the vehicle communication system 26 may be integrated with the vehicle controller 14 (e.g., on a same circuit board with the vehicle controller 14 or otherwise a part of the vehicle controller 14) without departing from the scope of the present disclosure.

The GNSS 28 is used to determine a geographical location of the vehicle 12. In an exemplary embodiment, the GNSS 28 is a global positioning system (GPS). In a non-limiting example, the GPS includes a GPS receiver antenna (not shown) and a GPS controller (not shown) in electrical communication with the GPS receiver antenna. The GPS receiver antenna receives signals from a plurality of satellites, and the GPS controller calculates the geographical location of the vehicle 12 based on the signals received by the GPS receiver antenna.

In an exemplary embodiment, the GNSS 28 additionally includes a map. The map includes information about infrastructure such as municipality borders, roadways, railways, sidewalks, buildings, and the like. Therefore, the geographical location of the vehicle 12 is contextualized using the map information. In another exemplary embodiment, the map is a detailed map including information such as, for example, road markings (e.g., lane lines) lane configuration information (e.g., lane starting and ending points, lane width, etc.), road configuration information (e.g., road width, road turn radius, etc.), and/or the like.

In a non-limiting example, the map is retrieved from a remote source using a wireless connection. In another non-limiting example, the map is stored in a database of the GNSS 28. It should be understood that various additional types of satellite-based radionavigation systems, such as, for example, the Global Positioning System (GPS), Galileo, GLONASS, and the BeiDou Navigation Satellite System (BDS) are within the scope of the present disclosure. The GNSS 28 is in electrical communication with the vehicle controller 14 as discussed above.

The automated driving system 18 is used to provide assistance to an occupant to increase occupant awareness and/or control behavior of the vehicle 12. In the scope of the present disclosure, the occupant includes a driver and/or a passenger of the vehicle 12. In the scope of the present disclosure, the automated driving system 18 encompasses systems which provide any level of assistance to the occupant (e.g., blind spot warning, lane departure warning, and/or the like) and systems which are capable of autonomously driving the vehicle 12 under some or all conditions (e.g., automated lane keeping, adaptive cruise control, fully autonomous driving, and/or the like). It should be understood that all levels of driving automation defined by, for example, SAE J3016 (i.e., SAE LEVEL 0, SAE LEVEL 1, SAE LEVEL 2, SAE LEVEL 3, SAE LEVEL 4, and SAE LEVEL 5) are within the scope of the present disclosure.

In an exemplary embodiment, the automated driving system 18 is configured to detect and/or receive information about the environment surrounding the vehicle 12 and process the information to provide assistance to the occupant. In some embodiments, the automated driving system 18 is a software module executed on the vehicle controller 14. In other embodiments, the automated driving system 18 includes a separate automated driving system controller, similar to the vehicle controller 14, capable of processing the information about the environment surrounding the vehicle 12. In an exemplary embodiment, the automated driving system 18 may operate in a manual operation mode, a partially automated operation mode, and a fully automated operation mode.

In the scope of the present disclosure, the manual operation mode means that the automated driving system 18 provides warnings or notifications to the occupant but does not intervene or control the vehicle 12 directly. In a non-limiting example, the automated driving system 18 receives information from the plurality of vehicle sensors 16. Using techniques such as, for example, computer vision, the automated driving system 18 understands the environment surrounding the vehicle 12 and provides assistance to the occupant. For example, if the automated driving system 18 identifies, based on data from the plurality of vehicle sensors 16, that the vehicle 12 is likely to collide with a remote vehicle, the automated driving system 18 may use the display 20 to provide a warning to the occupant.

In the scope of the present disclosure, the partially automated operation mode means that the automated driving system 18 provides warnings or notifications to the occupant and may intervene or control the vehicle 12 directly in certain situations. In a non-limiting example, the automated driving system 18 is additionally in electrical communication with components of the vehicle 12 such as a brake system, a propulsion system, and/or a steering system of the vehicle 12, such that the automated driving system 18 may control the behavior of the vehicle 12. In a non-limiting example, the automated driving system 18 may control the behavior of the vehicle 12 by applying brakes of the vehicle 12 to avoid an imminent collision. In another non-limiting example, the automated driving system 18 may control the steering system of the vehicle 12 to provide an automated lane keeping feature. In another non-limiting example, the automated driving system 18 may control the brake system, propulsion system, and steering system of the vehicle 12 to temporarily drive the vehicle 12 towards a predetermined destination. However, intervention by the occupant may be required at any time. In an exemplary embodiment, the automated driving system 18 may include additional components such as, for example, an eye tracking device configured to monitor an attention level of the occupant and ensure that the occupant is prepared to take over control of the vehicle 12.

In the scope of the present disclosure, the fully automated operation mode means that the automated driving system 18 uses data from the plurality of vehicle sensors 16 to understand the environment and control the vehicle 12 to drive the vehicle 12 to a predetermined destination without a need for control or intervention by the occupant.

The automated driving system 18 operates using a path planning algorithm which is configured to generate a safe and efficient trajectory for the vehicle 12 to navigate in the environment surrounding the vehicle 12. In an exemplary embodiment, the path planning algorithm is a machine learning algorithm trained to output control signals for the vehicle 12 based on input data collected from the plurality of vehicle sensors 16. In another exemplary embodiment, the path planning algorithm is a deterministic algorithm which has been programmed to output control signals for the vehicle 12 based on data collected from the plurality of vehicle sensors 16.

In a non-limiting example, the path planning algorithm generates a path that the vehicle 12 should follow to reach a destination while adhering to rules, regulations, and safety constraints. In the scope of the present disclosure, the path defines locations on a roadway which the vehicle 12 should pass through (i.e., a trajectory for the vehicle 12). For example, the path defines which lane the vehicle 12 is in, where in the lane the vehicle 12 is located, and a location and shape of any maneuvers (e.g., lane changes) executed by the vehicle 12. The path is generated based at least in part on the detailed map and a current state of the vehicle 12 (i.e., position, velocity, and orientation of the vehicle 12). The detailed map includes, for example, information about lane boundaries, road geometry, speed limits, traffic signs, and/or other relevant features. In an exemplary embodiment, the detailed map is stored in the media 24 of the vehicle controller 14, within the GNSS 28, and/or on a remote database or server. In exemplary embodiment, the path planning algorithm performs perception and mapping tasks to interpret data collected from the plurality of vehicle sensors 16 and create, update, and/or augment the detailed map.

It should be understood that the automated driving system 18 may include any software and/or hardware module configured to operate in the manual operation mode, the partially automated operation mode, or the fully automated operation mode as described above. The automated driving system 18 is in electrical communication with the vehicle controller 14, as discussed above.

The display 20 is used to provide information to the occupant of the vehicle 12. In the exemplary embodiment depicted in FIG. 1, the display 20 is a human-machine interface (HMI) located in view of the occupant and capable of displaying text, graphics and/or images. It is to be understood that HMI display systems including LCD displays, LED displays, and the like are within the scope of the present disclosure. Further exemplary embodiments where the display 20 is disposed in a rearview mirror are also within the scope of the present disclosure.

In another exemplary embodiment, the display 20 includes a head-up display (HUD) configured to provide information to the occupant by projecting text, graphics, and/or images upon the windscreen of the vehicle 12. The text, graphics, and/or images are reflected by the windscreen of the vehicle 12 and are visible to the occupant without looking away from a roadway ahead of the vehicle 12. In another exemplary embodiment, the display 20 includes an augmented reality head-up display (AR-HUD). The AR-HUD is a type of HUD configured to augment the occupant’s vision of the roadway ahead of the vehicle 12 by overlaying text, graphics, and/or images on physical objects in the environment surrounding the vehicle 12 within a field-of-view of the occupant.

In an exemplary embodiment, the occupant may interact with the display 20 using a human-interface device (HID), including, for example, a touchscreen, an electromechanical switch, a capacitive switch, a rotary knob, and the like. It should be understood that additional systems for displaying information to the occupant of the vehicle 12 are also within the scope of the present disclosure. The display 20 is in electrical communication with the vehicle controller 14, as discussed above.

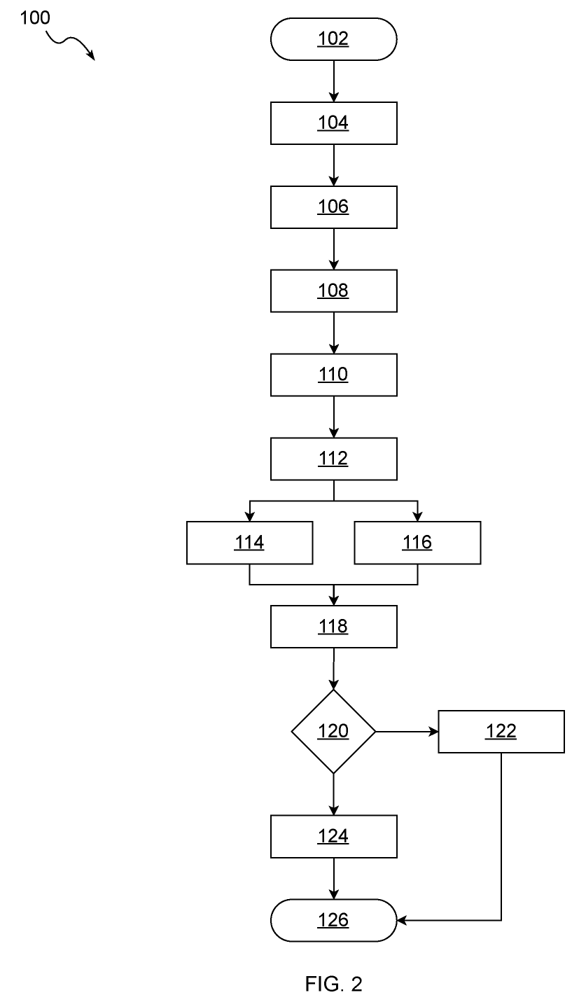

Referring to FIG. 2, a flowchart of the method 100 for operating an autonomous vehicle is shown. The method 100 begins at block 102 and proceeds to block 104. At block 104, the vehicle controller 14 uses the GNSS 28 to determine a location of the vehicle 12. In an exemplary embodiment, the vehicle controller 14 uses the detailed map to contextualize the location of the vehicle 12 within the environment relative to a roadway upon which the vehicle 12 is traveling based on, for example, lane lines and/or the like. After block 104, the method 100 proceeds to block 106.

At block 106, the vehicle controller 14 determines a route to a destination based at least in part on the location of the vehicle 12 determined at block 104. In the scope of the present disclosure, the destination is a location in the environment (e.g., identified by a street address) where the occupant intends to travel to with the vehicle 12. In a non-limiting example, the destination is received by the vehicle controller 14 using physical input by the occupant to the display 20. In another non-limiting example, the destination is received by the vehicle controller 14 via a voice command provided by the occupant.

In the scope of the present disclosure, the route is a series of instructions for transiting the environment to travel from the start (e.g., the location of the vehicle 12) to the destination. In a non-limiting example, the route is represented as a series of instructions for traveling on particular roads and/or performing turns, merges, and/or the like at particular waypoints in order to reach the destination. It should be understood that the route differs from the path (discussed above) in that the route is less granular than the path. For example, the route may describe which road the vehicle 12 will drive on, while the path may describe where on the road (i.e., relative to lanes, lane lines, etc.) the vehicle 12 will drive.

In an exemplary embodiment, to determine the route to the destination, a route planning algorithm is used. In a non-limiting example, the route planning algorithm determines an optimal route from a start to a destination based on various factors including, for example, road configuration, driving rules, traffic conditions, road closures, and/or the like. In a non-limiting example, the route planning algorithm chooses a route which results in a shortest distance traveled, a shortest time traveled, a fewest number of turns, and/or the like.

In an exemplary embodiment, the route planning algorithm is executed in the vehicle controller 14. In another exemplary embodiment, the route planning algorithm is executed by the GNSS 28. In another exemplary embodiment, the route planning algorithm is executed on a remote system (e.g., a webserver) and retrieved by the vehicle controller 14 using the vehicle communication system 26 (e.g., via an application programming interface (API)). It should be understood that the above discussion of the route planning algorithm is merely exemplary in nature, and that various additional methods for determining the route are also within the scope of the present disclosure. After block 106, the method 100 proceeds to block 108.

At block 108, the vehicle controller 14 generates a plurality of possible paths along the route determined at block 106. In an exemplary embodiment, the vehicle controller 14 uses the path planning algorithm of the automated driving system 18 to generate the plurality of possible paths. In the scope of the present disclosure, the plurality of possible paths represent valid paths (i.e., possible trajectories) that the vehicle 12 could take to travel along the route. For example, if the route includes a road with multiple lanes, the plurality of possible paths may include paths which cause the vehicle 12 to travel in different lanes of the roadway.

In another example, if the route includes exiting a highway via an exit on a right side of the highway, one of the plurality of possible paths may include changing lanes to a right-most lane of the highway one kilometer before the exit, while another of the plurality of possible paths may include changing lanes to the right-most lane of the highway five hundred meters before the exit. In another example, if the vehicle 12 is traveling in a lane which is ending, one of the plurality of possible paths may include exiting the ending lane two kilometers before the lane ends, while another of the plurality of possible paths may include exiting the ending lane three hundred meters before the lane ends. It should be understood that the plurality of possible paths may include many different possible paths, especially when complex road configurations and/or traffic situations are present.

In a non-limiting example, the path planning algorithm is configured to generate the plurality of possible paths based on inputs such as the route, a desired vehicle speed, and/or the like. In another non-limiting example, if the path planning algorithm is non-deterministic, the vehicle controller 14 uses the automated driving system 18 to execute the path planning algorithm multiple times to generate the plurality of possible paths. In another non-limiting example, if the path planning algorithm is deterministic, the vehicle controller 14 varies one or more input parameters to the path planning algorithm (e.g., desired vehicle speed, minimum vehicle separation distance, and/or the like) upon multiple executions of the path planning algorithm to generate the plurality of possible paths. It should be understood that various additional methods for generating the plurality of possible paths along the route are within the scope of the present disclosure. After block 108, the method 100 proceeds to block 110.

At block 110, the vehicle controller 14 identifies one or more decision points along each of the plurality of possible paths determined at block 108. In the scope of the present disclosure, a decision point is a location along a possible path where a road configuration change may result in a change in behavior of other vehicles on the roadway. In the scope of the present disclosure, a road configuration change is a change in a shape, path, arrangement, or function of a road or lanes on a road and/or an addition or removal of a feature on or near the road. In a non-limiting example, road configuration changes may include, but are not limited to, lane endings, lane beginnings, on-ramps, off-ramps, bifurcations, merges, road narrowing, road widening, roundabouts, intersections, crossovers, grade separations, median insertions, median removals, pedestrian crosswalks, traffic calming measures, slip lanes, and/or the like.

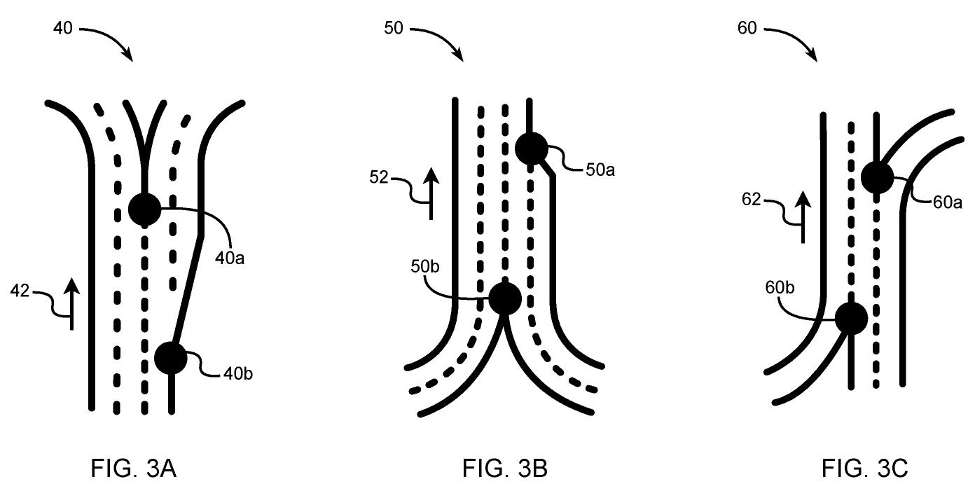

Referring to FIGS. 3A, 3B and 3C, exemplary roadways with exemplary decision points are shown. In FIG. 3A, a first exemplary roadway 40 is shown with a first exemplary decision point 40a and a second exemplary decision point 40b. Traffic flows in the direction indicated by the arrow 42. The first exemplary decision point 40a occurs at a bifurcation of the first exemplary roadway 40. In a non-limiting example, the first exemplary decision point 40a may cause vehicles to change behavior by switching lanes in order to follow an intended route. The second exemplary decision point 40b occurs at a new lane origin of the first exemplary roadway 40. In a non-limiting example, the second exemplary decision point 40b may cause vehicles to change behavior by switching lanes to enter the new lane.

In FIG. 3B, a second exemplary roadway 50 is shown with a first exemplary decision point 50a and a second exemplary decision point 50b. Traffic flows in the direction indicated by the arrow 52. The first exemplary decision point 50a occurs at a lane termination of the second exemplary roadway 50. In a non-limiting example, the first exemplary decision point 50a may cause vehicles to change behavior by switching lanes in order to exit the terminating lane. The second exemplary decision point 50b occurs at a multiple highway merge of the second exemplary roadway 50. In a non-limiting example, the second exemplary decision point 50b may cause vehicles to change behavior by merging onto the highway.

In FIG. 3C, a third exemplary roadway 60 is shown with a first exemplary decision point 60a and a second exemplary decision point 60b. Traffic flows in the direction indicated by the arrow 62. The first exemplary decision point 60a occurs at an off-ramp from the third exemplary roadway 60. In a non-limiting example, the first exemplary decision point 60a may cause vehicles to change behavior by switching lanes in order to use the off-ramp. The second exemplary decision point 60b occurs at an on-ramp to the third exemplary roadway 60. In a non-limiting example, the second exemplary decision point 60b may cause vehicles to change behavior by merging onto the highway.

It should be understood that the decision points discussed above with reference to FIGS. 3A, 3B, and 3C are merely exemplary in nature, and that decision points may be identified at many additional types of road configuration changes, including, for example, lane endings, lane beginnings, on-ramps, off-ramps, bifurcations, merges, road narrowing, road widening, roundabouts, intersections, crossovers, grade separations, median insertions, median removals, pedestrian crosswalks, bus lane additions, bicycle lane additions, traffic calming measures, slip lanes, and/or the like.

Referring again to FIG. 2, to identify the one or more decision points, the vehicle controller 14 analyzes the detailed map to find road configuration changes. In a non-limiting example, each road configuration change is identified to be a decision point. In another non-limiting example, certain types of road configuration changes, such as those discussed above in reference to FIGS. 3A, 3B, and 3C, are identified to be decision points. In an exemplary embodiment, a decision point is considered to be along one of the plurality of possible paths if it is within a predetermined distance of the one of the plurality of possible paths. In a non-limiting example, the vehicle controller 14 uses a machine learning algorithm which is trained to identify the one or more decision points based on the detailed map data along each of the plurality of possible paths. In another non-limiting example, the vehicle controller 14 uses a deterministic algorithm to identify the one or more decision points based on the detailed map data along each of the plurality of possible paths and pre-programmed road configuration identification rules. After block 110, the method 100 proceeds to block 112.

At block 112, the vehicle controller 14 determines a complexity score of each of the one or more decision points along each of the plurality of possible paths identified at block 110. In the scope of the present disclosure, the complexity score indicates a relative additional driving complexity imparted to one of the plurality of possible paths by one of the one or more decision points. In the scope of the present disclosure, increased driving complexity may be understood to correspond to performing maneuvers such as changing lanes, changing speed, and/or the like, performing multiple maneuvers in a short time frame, transiting within close proximity of other vehicles, and/or the like.

In an exemplary embodiment, the complexity score of each of the one or more decision points is determined based at least in part on a road configuration within a first predetermined radius of each of the one or more decision points. In a non-limiting example, the complexity score is positively correlated with a complexity of the road configuration. In a non-limiting example, if the road configuration includes multiple lanes of travel with multiple off-ramps and on-ramps (i.e., a relatively complex road configuration, for example, as shown in FIG. 3C) within the first predetermined radius of an exemplary decision point, the complexity score of the exemplary decision point is relatively high. In another non-limiting example, if the road configuration includes a single lane of travel with no other road features (i.e., a relatively simple road configuration) within the first predetermined radius of the exemplary decision point, the complexity score of the exemplary decision point is relatively low.

In another exemplary embodiment, the complexity score of each of the one or more decision points is determined based at least in part on a proximity of the one or more decision points to the corresponding possible path. In a non-limiting example, the complexity score of a first decision point of the one or more decision points along a first possible path of the plurality of possible paths is determined based at least in part on a proximity of the first decision point to the first possible path. In a non-limiting example, the complexity score of the first decision point of the one or more decision points along the first possible path of the plurality of possible paths is negatively correlated with a shortest distance between the first decision point and any location along the first possible path. This is because the further away a given possible path is from a given decision point, the less of an impact the conditions of the given decision point will have on a vehicle transiting the given possible path.

In another exemplary embodiment, the complexity score of each of the one or more decision points is determined based at least in part on a traffic condition within a second predetermined radius of each of the one or more decision points. In a non-limiting example, the complexity score is positively correlated with a complexity of the traffic condition. In a non-limiting example, if the traffic condition includes a high vehicle density (i.e., a relatively complex traffic condition) within the second predetermined radius of an exemplary decision point, the complexity score of the exemplary decision point is relatively high. In another non-limiting example, if the road configuration includes a low vehicle density (i.e., a relatively simple traffic condition) within the second predetermined radius of the exemplary decision point, the complexity score of the exemplary decision point is relatively low.

In another exemplary embodiment, the complexity score of each of the one or more decision points is determined based at least in part on a speed of the vehicle 12. In a non-limiting example, the complexity score is positively correlated with the speed of the vehicle 12. This is because increased speed of the vehicle 12 is generally associated with increased driving complexity to traverse road configuration changes at/near a decision point.

In another exemplary embodiment, the complexity score of each of the one or more decision points is determined based at least in part on a location of the vehicle 12. In a non-limiting example, the complexity score of a second decision point of the one or more decision points along a second possible path of the plurality of possible paths is negatively correlated with a distance between the second decision point and the location of the vehicle 12. This is because close proximity of the vehicle 12 to a decision point is generally associated with increased driving complexity to traverse road configuration changes at/near the decision point.

It should be understood that the complexity score of each of the one or more decision points may be determined using any one or more (i.e., any combination) of the factors discussed in the exemplary embodiments discussed above without departing from the scope of the present disclosure. After block 112, the method 100 proceeds to blocks 114 and 116.

At block 114, the vehicle controller 14 calculates a total complexity score of each of the plurality of possible paths. In an exemplary embodiment, the vehicle controller 14 calculates the total complexity score of each of the plurality of possible paths by summing the complexity score of each of the one or more decision points along each of the plurality of possible paths. In a non-limiting example, a first possible path includes a first decision point and a second decision point along the first possible path. Therefore, the total complexity score of the first possible path is a sum of the complexity score of the first decision point and the complexity score of the second decision point. In a non-limiting example, a second possible path includes a third decision point and a fourth decision point along the second possible path. Therefore, the total complexity score of the second possible path is a sum of the complexity score of the third decision point and the complexity score of the fourth decision point. After calculating the total complexity score of each of the plurality of possible paths, the method 100 proceeds to block 118, as will be discussed in greater detail below.

At block 116, the vehicle controller 14 identifies zero or more complex decision points along each of the plurality of possible paths. In the scope of the present disclosure, a complex decision point is defined as a decision point having a complexity score greater than a predetermined complexity threshold. In a non-limiting example, the predetermined complexity threshold is defined by an ability of the automated driving system 18 to control the vehicle 12 in complex driving situations, for example, based on hardware and/or software capabilities of the automated driving system 18. Accordingly, the predetermined complexity threshold may be adjusted based on changes in the capabilities of the automated driving system 18 due to, for example, software updates.

In an exemplary embodiment, to identify the zero or more complex decision points, the vehicle controller 14 compares the complexity score of each of the one or more decision points along each of the plurality of possible paths to the predetermined complexity threshold. The vehicle controller 14 then identifies the zero or more complex decision points along each of the plurality of possible paths, where the complexity score of each of the zero or more complex decision points is greater than the predetermined complexity threshold. After block 116, the method 100 proceeds to block 118.

At block 118, the vehicle controller 14 determines an optimal path selected from the plurality of possible paths. In an exemplary embodiment, the vehicle controller 14 determines the optimal path to be one of the plurality of possible paths having a lowest total complexity score as determined at block 114. In another exemplary embodiment, the vehicle controller 14 determines the optimal path to be one of the plurality of possible paths having a lowest total complexity score as determined at block 114 and having a least amount of complex decision points as determined at block 116. After block 118, the method 100 proceeds to block 120.

At block 120, the vehicle controller 14 determines whether the optimal path selected at block 118 includes any complex decision points. If at least one of the one or more decision points along the optimal path is one of the zero or more complex decision points, the method 100 proceeds to block 122. If none of the one or more decision points along the optimal path is one of the zero or more complex decision points, the method 100 proceeds to block 124, as will be discussed in greater detail below.

At block 122, the vehicle controller 14 performs an action in response to determining that at least one of the one or more decision points along the optimal path is one of the zero or more complex decision points. In an exemplary embodiment, the vehicle controller 14 uses the display 20 to provide an alert to the occupant of the vehicle 12. In a non-limiting example, the alert informs the occupant that the optimal path is complex and prompts the occupant to prepare to take over operation of the vehicle 12, and the automated driving system 18 is configured to follow the optimal path. In another non-limiting example, the alert prompts the occupant to immediately take over operation of the vehicle 12, and the automated driving system 18 ceases autonomous control of the vehicle 12. After block 122, the method 100 proceeds to enter a standby state at block 126.

At block 124, the vehicle controller 14 configures the automated driving system 18 to follow the optimal path determined at block 118. In an exemplary embodiment, to configure the automated driving system 18 to follow the optimal path, one or more waypoints defining the optimal path are transmitted to the automated driving system 18 by the vehicle controller 14. In a non-limiting example, the vehicle controller 14 uses the display 20 to provide information about the optimal path to the occupant.

In an exemplary embodiment, the vehicle controller 14 repeatedly exits the standby state 126 and restarts the method 100 at block 102. In a non-limiting example, the vehicle controller 14 exits the standby state 126 and restarts the method 100 on a timer, for example, every three hundred milliseconds. The method 100 is restarted to constantly recalculate the optimal path based on changing environmental conditions.

The system 10 and method 100 of the present disclosure offer several advantages. By dynamically choosing a least complex path, an efficiency and reliability of the automated driving system 18 is increased, and the likelihood of occupant intervention is decreased. Furthermore, in some examples, the method 100 is deterministic and may be implemented using a relatively low-power computing device (i.e., controller), allowing for onboard execution in the vehicle.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for operating an autonomous vehicle, the method comprising:
generating a plurality of possible paths;
identifying one or more decision points along each of the plurality of possible paths;
determining a complexity score of each of the one or more decision points along each of the plurality of possible paths;
determining an optimal path based at least in part on the complexity score of each of the one or more decision points along each of the plurality of possible paths; and
adjusting an operation of the autonomous vehicle based at least in part on the optimal path.

2. The method of claim 1, wherein determining the complexity score of each of the one or more decision points further comprises:
determining the complexity score of each of the one or more decision points based at least in part on a road configuration within a first predetermined radius of each of the one or more decision points, wherein the complexity score is positively correlated with a complexity of the road configuration.

3. The method of claim 2, wherein determining the complexity score of each of the one or more decision points further comprises:
determining the complexity score of each of the one or more decision points based at least in part on the plurality of possible paths, wherein the complexity score of a first decision point of the one or more decision points along a first possible path of the plurality of possible paths is negatively correlated with a shortest distance between the first decision point and any location along the first possible path.

4. The method of claim 3, wherein determining the complexity score of each of the one or more decision points further comprises:
determining the complexity score of each of the one or more decision points based at least in part on a traffic condition within a second predetermined radius of each of the one or more decision points, wherein the complexity score is positively correlated with a complexity of the traffic condition.

5. The method of claim 4, wherein determining the complexity score of each of the one or more decision points further comprises:
determining the complexity score of each of the one or more decision points based at least in part on a speed of the autonomous vehicle, wherein the complexity score is positively correlated with the speed of the autonomous vehicle.

6. The method of claim 1, wherein determining the optimal path based at least in part on the complexity score of each of the one or more decision points along each of the plurality of possible paths further comprises:
calculating a total complexity score of each of the plurality of possible paths by summing the complexity score of each of the one or more decision points along each of the plurality of possible paths; and
determining the optimal path to be one of the plurality of possible paths having a lowest total complexity score.

7. The method of claim 6, wherein determining the optimal path based at least in part on the complexity score of each of the one or more decision points along each of the plurality of possible paths further comprises:
comparing the complexity score of each of the one or more decision points along each of the plurality of possible paths to a predetermined complexity threshold;
identifying zero or more complex decision points along each of the plurality of possible paths, wherein the complexity score of each of the zero or more complex decision points is greater than the predetermined complexity threshold; and
determining the optimal path to be one of the plurality of possible paths having a lowest total complexity score and having a least amount of complex decision points.

8. The method of claim 7, wherein adjusting the operation of the autonomous vehicle further comprises:
configuring an automated driving system of the autonomous vehicle to follow the optimal path; and
providing an alert to an occupant of the autonomous vehicle in response to determining that at least one of the one or more decision points along the optimal path is one of the zero or more complex decision points.

9. The method of claim 1, wherein generating the plurality of possible paths further comprises:
determining a route to a destination based at least in part on a location of the autonomous vehicle; and
generating the plurality of possible paths along the route based at least in part on a detailed map along the route, wherein each of the plurality of possible paths includes a possible trajectory for the autonomous vehicle.

10. The method of claim 1, wherein identifying the one or more decision points further comprises:
identifying the one or more decision points along each of the plurality of possible paths based at least in part on a road configuration along each of the plurality of possible paths.

11. A system for operating an autonomous vehicle, the system comprising:
one or more vehicle sensors;
an automated driving system; and
a vehicle controller in electrical communication with the one or more vehicle sensors and the automated driving system, wherein the vehicle controller is programmed to:
determine a route to a destination based at least in part on a location of the autonomous vehicle determined using the one or more vehicle sensors;
generate a plurality of possible paths along the route based at least in part on a detailed map along the route, wherein each of the plurality of possible paths includes a possible trajectory for the autonomous vehicle;
identify one or more decision points along each of the plurality of possible paths;
determine a complexity score of each of the one or more decision points along each of the plurality of possible paths;
determine an optimal path based at least in part on the complexity score of each of the one or more decision points along each of the plurality of possible paths; and
adjust an operation of the automated driving system based at least in part on the optimal path.

12. The system of claim 11, wherein to determine the complexity score of each of the one or more decision points, the vehicle controller is further programmed to determine the complexity score of each of the one or more decision points based at least in part on:
a road configuration within a first predetermined radius of each of the one or more decision points, wherein the complexity score is positively correlated with a complexity of the road configuration;
the plurality of possible paths, wherein the complexity score of a first decision point of the one or more decision points along a first possible path of the plurality of possible paths is negatively correlated with a shortest distance between the first decision point and any location along the first possible path; and
a traffic condition within the first predetermined radius of each of the one or more decision points, wherein the complexity score is positively correlated with a complexity of the traffic condition.

13. The system of claim 12, wherein to determine the complexity score of each of the one or more decision points, the vehicle controller is further programmed to:
determine the complexity score of each of the one or more decision points based at least in part on a location of the autonomous vehicle, wherein the complexity score of a second decision point of the one or more decision points along a second possible path of the plurality of possible paths is negatively correlated with a distance between the second decision point and the location of the autonomous vehicle.

14. The system of claim 13, wherein to determine the optimal path based at least in part on the complexity score of each of the one or more decision points along each of the plurality of possible paths, the vehicle controller is further programmed to:
calculate a total complexity score of each of the plurality of possible paths by summing the complexity score of each of the one or more decision points along each of the plurality of possible paths; and
determine the optimal path to be one of the plurality of possible paths having a lowest total complexity score.

15. The system of claim 14, wherein to determine the optimal path based at least in part on the complexity score of each of the one or more decision points along each of the plurality of possible paths, the vehicle controller is further programmed to:
compare the complexity score of each of the one or more decision points along each of the plurality of possible paths to a predetermined complexity threshold;
identify zero or more complex decision points along each of the plurality of possible paths, wherein the complexity score of each of the zero or more complex decision points is greater than the predetermined complexity threshold; and
determine the optimal path to be one of the plurality of possible paths having a lowest total complexity score and having a least amount of complex decision points.

16. The system of claim 15, wherein the system further includes a display in electrical communication with the vehicle controller, and wherein to adjust the operation of the automated driving system, the vehicle controller is further programmed to:
configure the automated driving system of the autonomous vehicle to follow the optimal path; and
provide an alert to an occupant of the autonomous vehicle using the display in response to determining that at least one of the one or more decision points along the optimal path is one of the zero or more complex decision points.

17. The system of claim 16, wherein to identify the one or more decision points, the vehicle controller is further programmed to:
identify the one or more decision points along each of the plurality of possible paths based at least in part on a road configuration along each of the plurality of possible paths, wherein the road configuration is determined based at least in part on the detailed map.

18. A method for operating an autonomous vehicle, the method comprising:
determining a route to a destination based at least in part on a location of the autonomous vehicle;
generating a plurality of possible paths along the route based at least in part on a detailed map along the route, wherein each of the plurality of possible paths includes a possible trajectory for the autonomous vehicle;
identifying one or more decision points along each of the plurality of possible paths based at least in part on the detailed map along each of the plurality of possible paths, wherein each of the one or more decision points indicates a change in a road configuration along the route;
determining a complexity score of each of the one or more decision points along each of the plurality of possible paths;
determining an optimal path based at least in part on the complexity score of each of the one or more decision points along each of the plurality of possible paths; and
configuring an automated driving system of the autonomous vehicle to follow the optimal path.

19. The method of claim 18, wherein determining the complexity score of each of the one or more decision points further comprises determining the complexity score of each of the one or more decision points based at least in part on one or more of:
a road configuration within a first predetermined radius of each of the one or more decision points, wherein the complexity score is positively correlated with a complexity of the road configuration;
the plurality of possible paths, wherein the complexity score of a first decision point of the one or more decision points along a first possible path of the plurality of possible paths is negatively correlated with a shortest distance between the first decision point and any location along the first possible path;
a traffic condition within the first predetermined radius of each of the one or more decision points, wherein the complexity score is positively correlated with a complexity of the traffic condition;
a speed of the autonomous vehicle, wherein the complexity score is positively correlated with the speed of the autonomous vehicle; and
a location of the autonomous vehicle, wherein the complexity score of a second decision point of the one or more decision points along a second possible path of the plurality of possible paths is negatively correlated with a distance between the second decision point and the location of the autonomous vehicle.

20. The method of claim 19, wherein determining the optimal path based at least in part on the complexity score of each of the one or more decision points along each of the plurality of possible paths further comprises:
comparing the complexity score of each of the one or more decision points along each of the plurality of possible paths to a predetermined complexity threshold;
identifying zero or more complex decision points along each of the plurality of possible paths, wherein the complexity score of each of the zero or more complex decision points is greater than the predetermined complexity threshold;
calculating a total complexity score of each of the plurality of possible paths by summing the complexity score of each of the one or more decision points along each of the plurality of possible paths; and
determining the optimal path to be one of the plurality of possible paths having a lowest total complexity score and having a least amount of complex decision points.
